(19) United States
(12) Patent Application Publication
(10) Pub. No.: US 2010/0023136 A1
(43) Pub. Date: Jan. 28, 2010

(54) Control Apparatus and Related Method for a Computer System

(76) Inventors: Kuei-Kang Chang, Taipei City (TW); Yi-Hsien Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/502,228

(22) Filed: Jul. 13, 2009

(30) Foreign Application Priority Data
Jul. 22, 2008 (TW) 097127810

(51) Int. Cl. G05B 19/042

(52) U.S. Cl. 700/17; 700/19

(57) ABSTRACT

A control apparatus for a computer system, which includes a control signal generating unit for generating a input control signal, a selection signal generating unit for generating a selection signal, a control signal switching unit coupled to the control signal generating unit and the selection signal generating unit for outputting an enable signal according to the selection signal while receiving the input control signal, and a plurality of hardware signal control receivers coupled to the control signal switching unit, wherein a first hardware signal control receiver of the plurality of hardware signal control receivers is indicated according to the selection signal and informs an operating system of the computer system to execute an action according to the enable signal.

### BACKGROUND OF THE INVENTION

1. Field of the Invention

The present invention relates to a control apparatus for a computer system and related method, and more particularly, to a control apparatus capable of flexibly selecting various application functions depending on requirements and related method.

2. Description of the Prior Art

With rapid development of information technology, a new-generation of operating system platforms and corresponding hardware has various, frequently used functions for users. Progress of new functions has led to the popularity of information applications. Design of next-generation operating systems, combined with hardware, allows users to implement specific functions of the operating system through operation of an input apparatus. For example, in Microsoft Windows Vista™, a user can use a default function, such as performing a normal shutdown process or entering a sleep mode, through use of a power button.

However, some unpreventable drawbacks take place in practice. For example, the operating system and relative hardware may be directed to implement a specific function of the operating system after the user has operated a corresponding input apparatus. Therefore, while accidentally touching the input apparatus, the user must arrange for recovering an original usage state after the specific function has completed, causing the user inconvenience. In addition, because the design of the operating system and hardware can only implement the default function, the user is not able to modify or replace original settings with different situations, which further restricts range of utilization.

### SUMMARY OF THE INVENTION

It is therefore a primary objective of the claimed invention to provide a control apparatus and related method for a computer system.

The present invention discloses a control apparatus for a computer system. The control apparatus includes a control signal, a selection signal generating unit, a control signal switching unit, and a plurality of hardware signal control receivers. The control signal generating unit is utilized for generating an input control signal. The selection signal generating unit is utilized for generating a selection signal. The control signal switching unit is coupled to the control signal generating unit and the selection signal generating unit for outputting an enable signal according to the selection signal while receiving the input control signal. The plurality of hardware signal control receivers are coupled to the control signal switching unit, wherein a first hardware signal control receiver of the plurality of hardware signal control receivers is indicated according to the selection signal and informs an operating system of the computer system to execute an action according to the enable signal.

The present invention further discloses a control method for a computer system. The control method includes generating a selection signal and indicating a first hardware signal control receiver of a plurality of hardware signal control receivers according to the selection signal, and generating an input control signal and outputting an enable signal to the first hardware signal control receiver according to the selection signal while receiving the input control signal, so as to inform an operating system of the computer system to execute an action.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a control apparatus according to an embodiment of the present invention.

FIG. 2 is a schematic diagram of a procedure according to an embodiment of the present invention.

### DETAILED DESCRIPTION

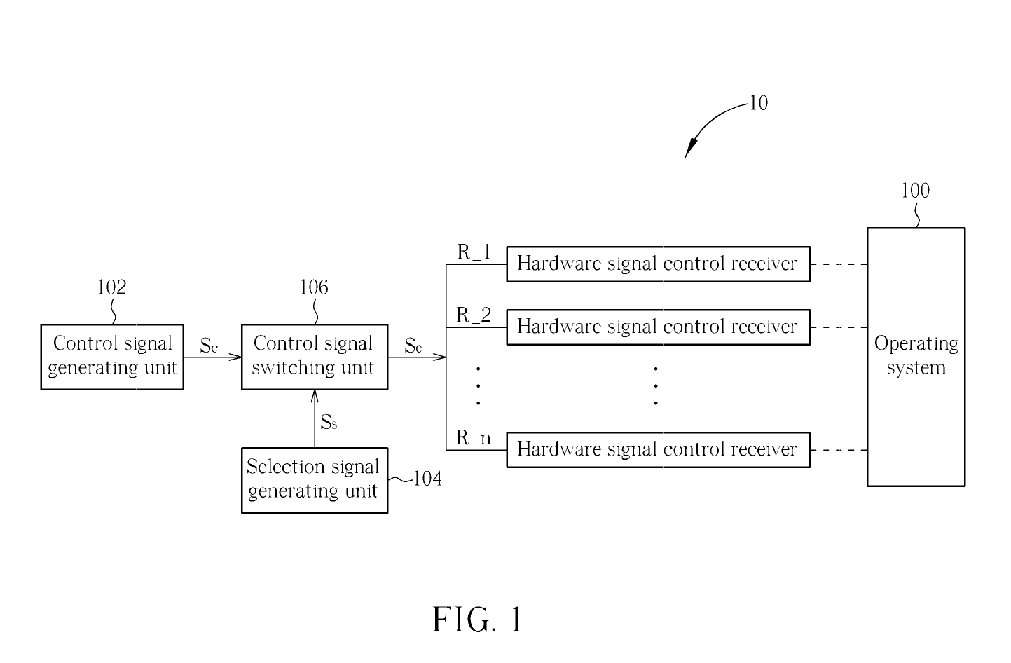

Please refer to the FIG. 1. FIG. 1 is a schematic diagram of a control apparatus 10 according to an embodiment of the present invention. The control apparatus 10 is utilized in a computer system for controlling or informing an operating system 100 of the computer system to execute a specific application function, such as performing a normal shutdown process or entering a sleep mode, popping up a menu, executing multimedia application programs, executing an Internet application program, performing tray ejection of an optical disk drive, etc., but these are not limitations of the present invention. The control apparatus 10 includes a control signal generating unit 102, a selection signal generating unit 104, a control signal switching unit 106, and a plurality of hardware signal control receivers R_1˜R_n. The control signal generating unit 102 is utilized for generating an input control signal Sc. The selection signal generating unit 104 is utilized for generating a selection signal Ss, so as to indicate a first hardware signal control receiver of the plurality of hardware signal control receivers R_1˜R_n. The control signal switching unit 106 is coupled to the control signal generating unit 102 and the selection signal generating unit 104. The control signal switching unit 106 is utilized for outputting an enable signal Se to the first hardware signal control receiver according to the selection signal Ss while receiving the input control signal Sc, and the first hardware signal control receiver informs the operating system 100 of the computer system to execute an action according to the enable signal Se. As can be seen, in the control apparatus 10, when the control signal switching unit 106 receives the input control signal Sc, the control signal switching unit 106 outputs the enable signal Se to the first hardware signal control receiver indicated by the selection signal Ss, and then the first hardware signal control receiver informs the operating system 100 to execute the corresponding function according to the enable signal Se. As a result, through the embodiment of the present invention, users or manufacturers are capable of flexibly using various application functions so as to enhance usage convenience.

In FIG.1, the operating system 100 is preferably Microsoft Windows Vista™. Moreover, those skilled in the art should appreciate that various other operating systems, software, or firmware can be used as the operating system 100. Therefore, through the control apparatus 10, the users are capable of choosing or determining application function corresponding to the control signal generating unit 102 by the selection signal generating unit 104, so as to enable a specific hardware signal control receiver of the plurality of hardware signal control receivers R_1˜R_n. In such a condition, the control signal switching unit 106 outputs the enable signal Se to the specific hardware signal control receiver according to the selection signal Ss after the user generates the selection signal Sc through the control signal generating unit 102. The specific hardware signal control receiver activates the corresponding application function according to the enable signal Se. In other words, the users are capable of modifying or replacing original settings with different situations in order to use various application functions for enhancing usage convenience.

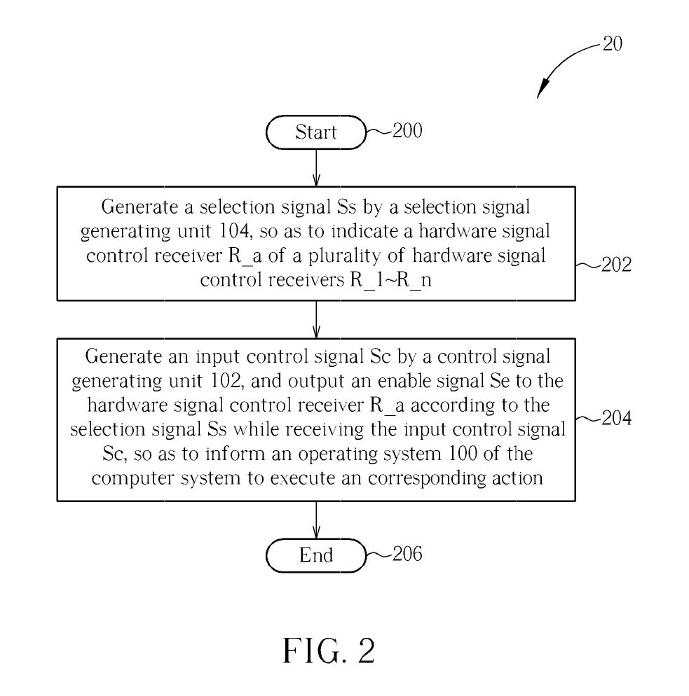

As to an operating procedure of the control apparatus 10 shown in FIG. 1, please further refer to FIG. 2. FIG. 2 is a schematic diagram of a procedure 20 according to an embodiment of the present invention. The procedure 20 comprises the following steps:

Step 200: Start.

Step 202: Generate a selection signal Ss by a selection signal generating unit 104, so as to indicate a hardware signal control receiver R_a of a plurality of hardware signal control receivers R_1˜R_n.

Step 204: Generate an input control signal Sc by a control signal generating unit 102, and output an enable signal Se to the hardware signal control receiver R_a according to the selection signal Ss while receiving the input control signal Sc, so as to inform an operating system 100 of the computer system to execute a corresponding action.

Step 206: End.

According to the procedure 20, when the control signal switching unit 106 receives the input control signal Sc, the control signal switching unit 106 then outputs the enable signal Se to the specific hardware signal control receiver R_a indicated by the selection signal Ss, and the specific hardware signal control receiver R_a informs the operating system 100 to execute the corresponding action. In the prior art, the users can only perform the default function without any other choice. Comparatively, through the embodiment of the present invention, users or manufacturers are capable of flexibly using various application functions so as to enhance usage convenience.

Note that the control apparatus 10 is an exemplary embodiment of the present invention, and those skilled in the art can make alternations and modifications accordingly. For example, any kind of device which can generate the input control signal Sc by the user is suitable for the control signal generating unit 102, such as buttons, switches, control panels, etc., but these are not limitations of the present invention. Each of the plurality of hardware signal control receivers R_1˜R_n is capable of informing the operating system 100 to execute a corresponding action, such as performing a normal shutdown process or entering a sleep mode, popping up a menu, executing multimedia application programs, executing an Internet application program, performing tray ejection of an optical disk drive, etc., but these are not limitations of the present invention. Besides, the plurality of hardware signal control receivers R_1˜R_n can not only inform the operating system 100 to execute a corresponding action, but can also inform a firmware or software to execute a corresponding action. In addition, the selection signal generating unit 104 is utilized for generating the selection signal Ss, so as to indicate one or more hardware signal control receivers of the plurality of hardware signal control receivers R_1˜R_n, i.e. not only can the users select the desired functions, but they may also select various functions at the same time. Preferably, the selection signal generating unit 104 can adjust the generated selection signal Ss according to the requirement for the users or manufacturers via a basic input and output system. Furthermore, the selection signal generating unit 104 can be integrated in the basic input and output system. The control signal switching unit 106 preferably generates and outputs the enable signal Se to the hardware signal control receiver indicated by the selection signal Ss through the basic input and output system setup.

Therefore, in the embodiment of the present invention, if the user wants to execute a multimedia application program and perform tray ejection of an optical disk drive after pressing down a power-on button, a user need only generate a proper selection signal Ss through the selection signal generating unit 104 using the basic input and output system setup, so as to indicate the hardware signal control receivers corresponding to executing a multimedia application program and performing tray ejection of the optical disk drive, such as R_b1 and R_b2. In such a condition, the user presses down the power-on button to generate the input control signal Sc. After the control signal switching unit 106 receives the input control signal Sc, the control signal switching unit 106 outputs the enable signal Se to the hardware signal control receivers R_b1, R_b2, so as to inform the operating system 100 or related software to execute the multimedia application program and perform tray ejection of the optical disk drive. Similarly, if the user wants to pop up a management menu to select a function after pressing down the power-on button to avoid unpreventable shutdown caused by accidentally touching the power-on button, the user need only generate a proper selection signal Ss by the selection signal generating unit 104 through the basic input and output system setup, so as to indicate the hardware signal control receivers corresponding to popping up the management menu, such as R_c. Thus, after the user presses down the power-on button, the control signal switching unit 106 can output the enable signal Se to the hardware signal control receivers R_c, so as to inform the operating system 100 or related software to execute the action of popping up the management menu. Similarly, if the user wants to shut down the computer system after pressing down the power-on button, it can be done accordingly.

In conclusion, the operating system and relative hardware in the prior art may be directed to implement a specific function of the operating system after the user operates a corresponding input apparatus. The design of the operating system and hardware in the prior art can only implement the default function, so that the user is not able to modify or replace original settings with different situations. In contrast to the prior art, through the embodiment of the present invention, the users are capable of avoiding accidentally touching the button and selecting various functions at the same time, and more importantly, the users or the manufacturers are capable of flexibly selecting various application functions depending on their requirements, so as to enhance usage convenience, and save space and cost of the computer system.

Those skilled in the art will readily observe that numerous modifications and alterations of the device and method may be made while retaining the teachings of the invention.

What is claimed is:

1. A control apparatus for a computer system, the control apparatus comprising:
a control signal generating unit for generating an input control signal;
a selection signal generating unit for generating a selection signal;
a control signal switching unit coupled to the control signal generating unit and the selection signal generating unit for outputting an enable signal according to the selection signal while receiving the input control signal; and
a plurality of hardware signal control receivers coupled to the control signal switching unit, wherein a first hardware signal control receiver of the plurality of hardware signal control receivers is indicated according to the selection signal and informs an operating system of the computer system to execute an action according to the enable signal.

2. The control apparatus of claim 1, wherein the control signal generating unit is a button.

3. The control apparatus of claim 1, wherein the control signal generating unit is a switch.

4. The control apparatus of claim 1, wherein the control signal generating unit is a control panel.

5. The control apparatus of claim 1, wherein the control signal switching unit is integrated with a basic input and output system of the computer system.

6. The control apparatus of claim 1, wherein the plurality of hardware signal control receivers are further utilized for informing a software of the computer system to execute the action according to the enable signal.

7. The control apparatus of claim 1, wherein the plurality of hardware signal control receivers are further utilized for informing a firmware of the computer system to execute the action according to the enable signal.

8. The control apparatus of claim 1, wherein the selection signal generating unit is integrated with a basic input and output system of the computer system.

9. A control method for a computer system, the control method comprising:
generating a selection signal and indicating a first hardware signal control receiver of a plurality of hardware signal control receivers according to the selection signal; and
generating an input control signal and outputting an enable signal to the first hardware signal control receiver according to the selection signal while receiving the input control signal, so as to inform an operating system of the computer system to execute an action.

10. The control method of claim 9, wherein the input control signal is generated by a button.

11. The control method of claim 9, wherein the input control signal is generated by a switch.

12. The control method of claim 9, wherein the input control signal is generated by a control panel.

13. The control method of claim 9, wherein outputting the enable signal to the first hardware signal control receiver according to the selection signal while receiving the input control signal so as to inform the operating system of the computer system to execute an action comprises outputting the enable signal to the first hardware signal control receiver according to the selection signal while receiving the input control signal so as to inform a software of the computer system to execute the action.

14. The control method of claim 9, wherein outputting the enable signal to the first hardware signal control receiver according to the selection signal while receiving the input control signal so as to inform the operating system of the computer system to execute an action comprises outputting the enable signal to the first hardware signal control receiver according to the selection signal while receiving the input control signal so as to inform a firmware of the computer system to execute the action.
